(19) United States
(12) Patent Application Publication
(10) Pub. No.: US 2006/0144814 A1
(43) Pub. Date: Jul. 6, 2006

(54) Imprint lithography

(75) Inventors: Aleksey Yurievich Kolesnychenko, Helmond (NL); Helmar Van Santen, Amsterdam (NL); Yvonne Kruijt-Stegeman, Eindhoven (NL); Peter Bartus Leonard Meijer, Eindhoven (NL)

Correspondence Address: PILLSBURY WINTHROP SHAW PITTMAN, LLP, P.O. BOX 10500, MCLEAN, VA, 22102, US

(73) Assignees: ASML NETHERLANDS B.V., Veldhoven (NL); KONINKLIJKE PHILIPS ELECTRONICS N.V., Eindhoven (NL)

(21) Appl. No.: 11/025,606

(22) Filed: Dec. 30, 2004

(51) Int. Cl. C23F 1/00; B44C 1/22; C03C 15/00; B29D 11/00

(52) U.S. Cl. 216/41; 264/1.31

(57) ABSTRACT

An imprinting method is disclosed, which in an embodiment, involves contacting an imprintable medium on a substrate with a template to form an imprint in the medium comprising a pattern feature and an area of reduced thickness, separating the template from the imprinted medium, and, after separating the template from the imprinted medium, providing a layer of an etch resistant material on the pattern feature.

### FIELD

The invention relates to imprint lithography.

A lithographic apparatus is a machine that applies a desired pattern onto a target portion of a substrate. Lithographic apparatus are conventionally used, for example, in the manufacture of integrated circuits (ICs), flat panel displays and other devices involving fine structures.

It is desirable to reduce the size of features in a lithographic pattern because this allows for a greater density of features on a given substrate area. In photolithography, the increased resolution may be achieved by using radiation of a short wavelength. However, there are problems associated with such reductions. Lithographic apparatus using 193 nm wavelength radiation are starting to be adopted but even at this level, diffraction limitations may become a barrier. At lower wavelengths, the transparency of projection system materials is poor. Thus, optical lithography capable of enhanced resolution will likely require complex optics and rare materials and thus will be expensive.

An alternative method to printing sub-100 nm features, known as imprint lithography, comprises transferring a pattern to a substrate by imprinting a pattern into an imprintable medium using a physical mould or template. The imprintable medium may be the substrate or a material coated onto a surface of the substrate. The imprintable medium may be functional or may be used as a “mask” to transfer a pattern to an underlying surface. The imprintable medium may, for instance, be provided as a resist deposited on a substrate, such as a semiconductor material, to which the pattern defined by the template is to be transferred. Imprint lithography is thus essentially a moulding process on a micrometer or nanometer scale in which the topography of a template defines the patterns created on a substrate. Patterns may be layered as with optical lithography processes so that in principle imprint lithography could be used for such applications as integrated circuit manufacture.

The resolution of imprint lithography is limited only by the resolution of the template fabrication process. For instance, imprint lithography has been used to produce features in the sub-50 nm range with good resolution and line edge roughness. In addition, imprint processes may not require the expensive optics, advanced illumination sources or specialized resist materials typically required for optical lithography processes.

### SUMMARY

According to an aspect of the invention, there is provided an imprinting method, comprising:

contacting an imprintable medium on a substrate with a template to form an imprint in the medium comprising a pattern feature and an area of reduced thickness;

separating the template from the imprinted medium; and

after separating the template from the imprinted medium, providing a layer of an etch resistant material on the pattern feature.

In this way, features of the pattern imprinted into the medium may be protected from erosion in subsequent otherwise non-selective etching, thereby improving the aspect ratio of the imprinted pattern features. It should be understood that references to one or more areas of ‘reduced thickness’ are intended to relate to area(s) of the imprintable medium which are also commonly referred to as a residual layer, which do not form part of the final pattern on the substrate or transfer layer (if present). The area(s) of reduced thickness is intended to be removed in a subsequent non-selective etching prior to etching the substrate or transfer layer (if present). An additional or alternative advantage is that the choice of materials for the imprintable medium may be widened because this is often limited to materials which have the desired etching properties.

In an embodiment, the method further comprises providing a volume of the imprintable medium on the substrate.

In an embodiment, the etch resistant material is provided only on the pattern feature. In this way, one or more areas of reduced thickness remain susceptible to erosion and removal in subsequent etching. In an embodiment, the etch resistant material is provided on a surface of the pattern feature which is distal from the substrate. The pattern feature surface furthest from the substrate will be the feature's top surface when the substrate is located underneath the imprintable medium as is typically the case.

In an embodiment, the etch resistant material is provided on the pattern feature by low angle deposition and/or by shadow sputtering.

In an embodiment, the method further comprises etching the area of reduced thickness to expose a region of a surface of the substrate. Appropriately, the method may further comprise etching the exposed region of the surface of the substrate.

In an embodiment, an intermediate layer is provided between the substrate and the imprintable medium. In this case, the method further comprises etching the area of reduced thickness to expose a region of a surface of the intermediate layer. Additionally, the method may further comprise etching the exposed region of the surface of the intermediate layer to expose a region of a surface of the substrate, which may be followed by etching the exposed region of the surface of the substrate.

According to an aspect of the invention, there is provided a method for patterning a substrate, comprising:

contacting an imprintable medium on a substrate with a template to form an imprint in the medium comprising a pattern feature and an area of reduced thickness;

separating the template from the imprinted medium;

providing a layer of an etch resistant material on the pattern feature;

etching the area of reduced thickness to expose a region of the substrate; and

etching the exposed region of the substrate.

In an embodiment, the etch resistant material is provided only on the pattern feature. In an embodiment, the etch resistant material is provided on a surface of the pattern feature which is distal from the substrate. In an embodiment, the etch resistant material is provided on the pattern feature by low angle deposition and/or by shadow sputtering.

According to an aspect of the invention, there is provided an imprinting apparatus, comprising:

a substrate holder configured to hold a substrate having an imprintable medium thereon;

a template holder configured to cause a template supported by the template holder to contact the medium to form an imprint in the medium, the imprint comprising a pattern feature and an area of reduced thickness, and to cause the template to separate from the imprinted medium; and

a material dosing device configured to provide a layer of an etch resistant material on the pattern feature.

In an embodiment, the material dosing device is operable to provide the etch resistant material only on the pattern feature. In an embodiment, the material dosing device is operable to provide the etch resistant material on a surface of the pattern feature which is distal from the substrate. In an embodiment, the material dosing device comprises a low angle shadow sputtering device.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a-1c illustrate examples of soft, hot and UV lithography process respectively;

FIG. 2 illustrates a two step etching process employed when hot and UV imprint lithography is used to pattern a resist layer;

FIG. 3 illustrates relative dimensions of template features compared to the thickness of a typical imprintable resist layer deposited on a substrate; and

FIG. 4 illustrates deposition of an etch-resistant material in accordance with an embodiment of the invention.

### DETAILED DESCRIPTION

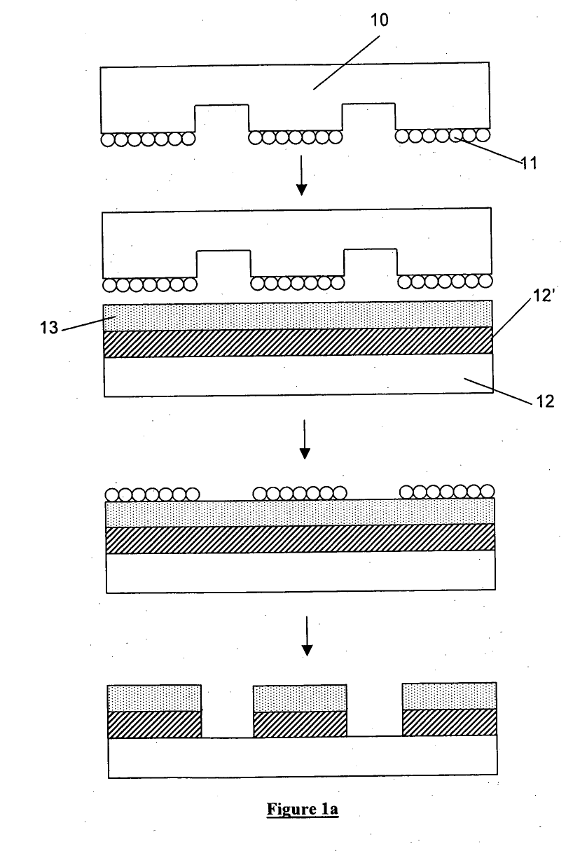

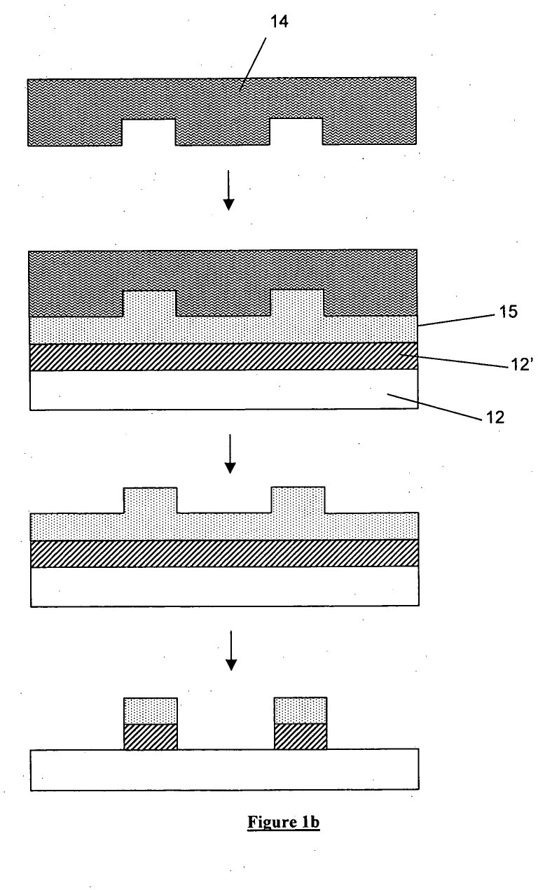

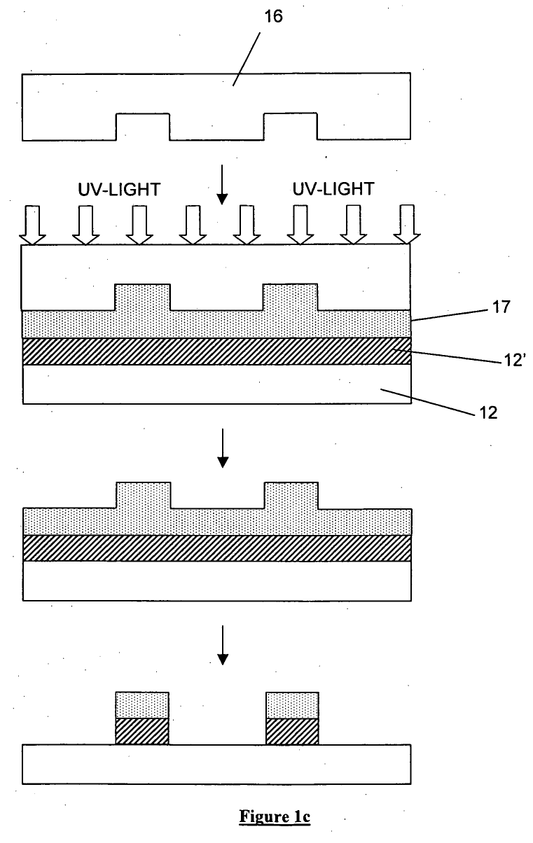

There are two principal approaches to imprint lithography which will be termed generally as hot imprint lithography and UV imprint lithography. There is also a third type of “printing” lithography known as soft lithography. Examples of these are illustrated in FIGS. 1a to 1c.

FIG. 1a schematically depicts the soft lithography process which involves transferring a layer of molecules 11 (typically an ink such as a thiol) from a flexible template 10 (typically fabricated from polydimethylsiloxane (PDMS)) onto a resist layer 13 which is supported upon a substrate 12 and planarization and transfer layer 12′. The template 10 has a pattern of features on its surface, the molecular layer being disposed upon the features. When the template is pressed against the resist layer, the layer of molecules 11 stick to the resist. Upon removal of the template from the resist, the layer of molecules 11 stick to the resist, the residual layer of resist is etched such that the areas of the resist not covered by the transferred molecular layer are etched down to the substrate.

The template used in soft lithography may be easily deformed and may therefore not be suited to high resolution applications, e.g. on a nanometer scale, since the deformation of the template may adversely affect the imprinted pattern. Furthermore, when fabricating multiple layer structures, in which the same region will be overlaid multiple times, soft imprint lithography may not provide overlay accuracy on a nanometer scale.

Hot imprint lithography (or hot embossing) is also known as nanoimprint lithography (NIL) when used on a nanometer scale. The process uses a harder template made from, for example, silicon or nickel, which are more resistant to wear and deformation. This is described for instance in U.S. Pat. No. 6,482,742 and illustrated in FIG. 1b. In a typical hot imprint process, a solid template 14 is imprinted into a thermosetting or a thermoplastic polymer resin 15, which has been cast on the surface of substrate. The resin may, for instance, be spin coated and baked onto the substrate surface or more typically (as in the example illustrated) onto a planarization and transfer layer 12′. It should be understood that the term “hard” when describing an imprint template includes materials which may generally be considered between “hard” and “soft” materials, such as for example “hard” rubber. The suitability of a particular material for use as an imprint template is determined by its application requirements.

When a thermosetting polymer resin is used, the resin is heated to a temperature such that, upon contact with the template, the resin is sufficiently flowable to flow into the pattern features defined on the template. The temperature of the resin is then increased to thermally cure (e.g. crosslink) the resin so that it solidifies and irreversibly adopts the desired pattern. The template may then be removed and the patterned resin cooled.

Examples of thermoplastic polymer resins used in hot imprint lithography processes are poly(methyl methacrylate), polystyrene, poly(benzyl methacrylate) or poly(cyclohexyl methacrylate). The thermoplastic resin is heated so that it is in a freely flowable state immediately prior to imprinting with the template. It is typically necessary to heat thermoplastic resin to a temperature considerably above the glass transition temperature of the resin. The template is pressed into the flowable resin and sufficient pressure is applied to ensure the resin flows into all the pattern features defined on the template. The resin is then cooled to below its glass transition temperature with the template in place whereupon the resin irreversibly adopts the desired pattern. The pattern will consist of the features in relief from a residual layer of the resin which may then be removed by an appropriate etch process to leave only the pattern features.

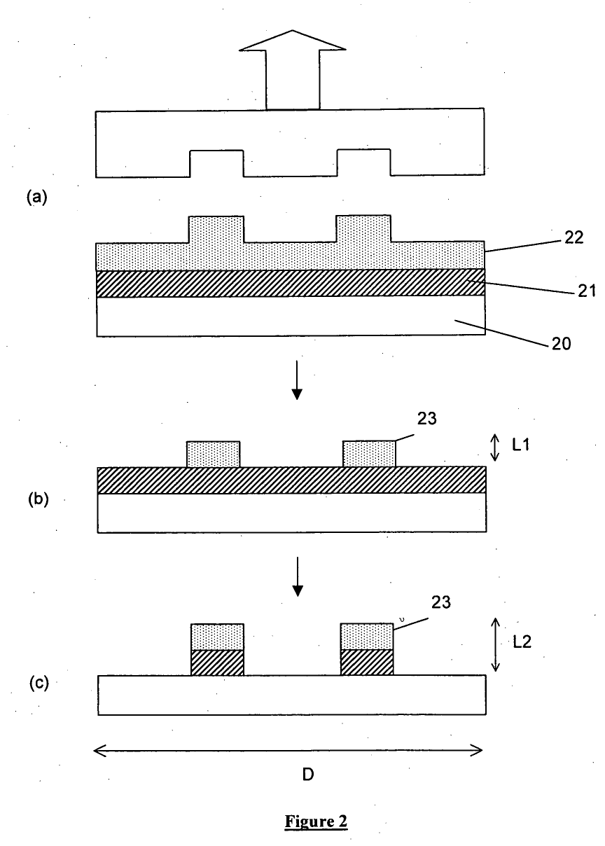

Upon removal of the template from the solidified resin, a two-step etching process is typically performed as illustrated in FIGS. 2a to 2c. The substrate 20 has a planarization and transfer layer 21 immediately upon it, as shown in FIG. 2a. The purpose of the planarization and transfer layer is twofold. It acts to provide a surface substantially parallel to that of the template, which helps ensure that the contact between the template and the resin is parallel, and also to improve the aspect ratio of the printed features, as will be described below.

After the template has been removed, a residual layer 22 of the solidified resin is left on the planarization and transfer layer 21, shaped in the desired pattern. The first etch is isotropic and removes parts of the residual layer 22, resulting in a poor aspect ratio of features where L1 is the height of the features 23, as shown in FIG. 2b. The second etch is anisotropic (or selective) and improves the aspect ratio. The anisotropic etch removes those parts of the planarization and transfer layer 21 which are not covered by the solidified resin, increasing the aspect ratio of the features 23 to (L2/D), as shown in FIG. 2c. The resulting polymer thickness contrast left on the substrate after etching can be used as for instance a mask for dry etching if the imprinted polymer is sufficiently resistant, for instance as a step in a lift-off process.

Hot imprint lithography suffers from a disadvantage in that not only must the pattern transfer be performed at a higher temperature, but also relatively large temperature differentials might be required in order to ensure the resin is adequately solidified before the template is removed. Temperature differentials between 35 and 100° C. may be needed. Differential thermal expansion between, for instance, the substrate and template may then lead to distortion in the transferred pattern. This may be exacerbated by the relatively high pressure required for the imprinting step, due the viscous nature of the imprintable material, which can induce mechanical deformation in the substrate, again distorting the pattern.

UV imprint lithography, on the other hand, does not involve such high temperatures and temperature changes nor does it require such viscous imprintable materials. Rather, UV imprint lithography involves the use of a partially or wholly transparent template and a UV-curable liquid, typically a monomer such as an acrylate or methacrylatee. In general, any photopolymerisable material could be used, such as a mixture of monomers and an initiator. The curable liquid may also, for instance, include a dimethyl siloxane derivative. Such materials are less viscous than the thermosetting and thermoplastic resins used in hot imprint lithography and consequently move much faster to fill template pattern features. Low temperature and low pressure operation also favors higher throughput capabilities.

An example of a UV imprint process is illustrated in FIG. 1c. A quartz template 16 is applied to a UV curable resin 17 in a similar manner to the process of FIG. 1b. Instead of raising the temperature as in hot embossing employing thermosetting resins, or temperature cycling when using thermoplastic resins, UV radiation is applied to the resin through the quartz template in order to polymerise and thus cure it. Upon removal of the template, the remaining steps of etching the residual layer of resist are the same or similar as for the hot embossing process described above. The UV curable resins typically used have a much lower viscosity than typical thermoplastic resins so that lower imprint pressures can be used. Reduced physical deformation due to the lower pressures, together with reduced deformation due to high temperatures and temperature changes, makes UV imprint lithography suited to applications requiring high overlay accuracy. In addition, the transparent nature of UV imprint templates can accommodate optical alignment techniques simultaneously to the imprinting.

Although this type of imprint lithography mainly uses UV curable materials, and is thus generically referred to as UV imprint lithography, other wavelengths of radiation may be used to cure appropriately selected materials (e.g., activate a polymerization or cross linking reaction). In general, any radiation capable of initiating such a chemical reaction may be used if an appropriate imprintable material is available. Alternative “activating radiation” may, for instance, include visible light, infrared radiation, x-ray radiation and electron beam radiation. In the general description above, and below, references to UV imprint lithography and use of UV radiation are not intended to exclude these and other activating radiation possibilities.

As an alternative to imprint systems using a planar template which is maintained substantially parallel to the substrate surface, roller imprint systems have been developed. Both hot and UV roller imprint systems have been proposed in which the template is formed on a roller but otherwise the imprint process is very similar to imprinting using a planar template. Unless the context requires otherwise, references to an imprint template include references to a roller template.

There is a particular development of UV imprint technology known as step and flash imprint lithography (SFIL) which may be used to pattern a substrate in small steps in a similar manner to optical steppers conventionally used, for example, in IC manufacture. This involves printing small areas of the substrate at a time by imprinting a template into a UV curable resin, ‘flashing’ UV radiation through the template to cure the resin beneath the template, removing the template, stepping to an adjacent region of the substrate and repeating the operation. The small field size of such step and repeat processes may help reduce pattern distortions and CD variations so that SFIL may be particularly suited to manufacture of IC and other devices requiring high overlay accuracy.

Although in principle the UV curable resin can be applied to the entire substrate surface, for instance by spin coating, this may be problematic due to the volatile nature of UV curable resins.

One approach to addressing this problem is the so-called ‘drop on demand’ process in which the resin is dispensed onto a target portion of the substrate in droplets by a dosing apparatus (e.g., a spout or other dispenser) immediately prior to imprinting with the template. The liquid dispensing is controlled so that a predetermined volume of liquid is deposited on a particular target portion of the substrate. The liquid may be dispensed in a variety of patterns and the combination of carefully controlling liquid volume and placement of the pattern can be employed to confine patterning to the target area.

Dispensing the resin on demand as mentioned is not a trivial matter. The size and spacing of the droplets are carefully controlled to ensure there is sufficient resin to fill template features while at the same time minimizing excess resin which can be rolled to an undesirably thick or uneven residual layer since as soon as neighboring drops touch the resin will have nowhere to flow.

Although reference is made above to depositing UV curable liquids onto a substrate, the liquids could also be deposited on the template and in general the same techniques and considerations will apply.

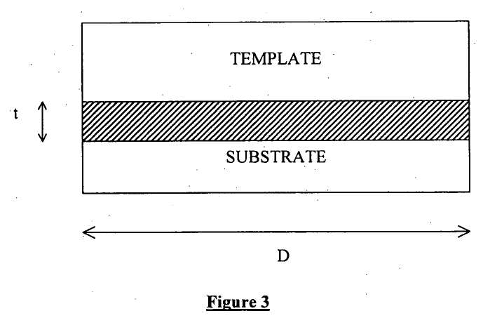

FIG. 3 illustrates the relative dimensions of the template, imprintable material (curable monomer, thermosetting resin, thermoplastic, etc.), and substrate. The ratio of the width of the substrate, D, to the thickness of the curable resin layer, t, is of the order of 10⁶. It will be appreciated that, in order to avoid the features projecting from the template damaging the substrate, the dimension t should be greater than the depth of the projecting features on the template.

The residual layer of imprintable material left after stamping is useful in protecting the underlying substrate, but may also impact obtaining high resolution and/or overlay accuracy. The first ‘breakthrough’ etch is isotropic (non-selective) and will thus to some extent erode the features imprinted as well as the residual layer. This may be exacerbated if the residual layer is overly thick and/or uneven.

This etching may, for instance, lead to a variation in the thickness of features ultimately formed on the underlying substrate (i.e. variation in the critical dimension). The uniformity of the thickness of a feature that is etched in the transfer layer in the second anisotropic etch is dependant upon the aspect ratio and integrity of the shape of the feature left in the resin. If the residual resin layer is uneven, then the non-selective first etch may leave some of these features with “rounded” tops so that they are not sufficiently well defined to ensure good uniformity of feature thickness in the second and any subsequent etch process.

In principle, the above problem may be reduced by ensuring the residual layer is as thin as possible but this may require application of undesirably large pressures (possibly increasing substrate deformation) and relatively long imprinting times (perhaps reducing throughput).

As noted above, the resolution of the features on the template surface is a limiting factor on the attainable resolution of features printed on the substrate. The templates used for hot and UV imprint lithography are generally formed in a two-stage process. Initially, the required pattern is written using, for example, electron beam writing to give a high resolution pattern in resist. The resist pattern is then transferred into a thin layer of chrome which forms the mask for the final, anisotropic etch step to transfer the pattern into the base material of the template. Other techniques such as for example ion-beam lithography, X-ray lithography, extreme UV lithography, epitaxial growth, thin film deposition, chemical etching, plasma etching, ion etching or ion milling could be used. Generally, a technique capable of very high resolution will be desired as the template is effectively a 1× mask with the resolution of the transferred pattern being limited by the resolution of the pattern on the template.

The release characteristics of the template are also a consideration. The template may, for instance, be treated with a surface treatment material to form a thin release layer on the template having a low surface energy (a thin release layer may also be deposited on the substrate).

Another consideration in the development of imprint lithography is the mechanical durability of the template. The template may be subjected to large forces during stamping of the imprintable medium, and in the case of hot imprint lithography, it may also be subjected to high pressure and temperature. The force, pressure and/or temperature may cause wearing of the template, and may adversely affect the shape of the pattern imprinted upon the substrate.

In hot imprint lithography, a potential advantage may be realized in using a template of the same or similar material to the substrate to be patterned in order to help reduce differential thermal expansion between the two. In UV imprint lithography, the template is at least partially transparent to the activation radiation and accordingly quartz templates are used.

Although specific reference may be made in this text to the use of imprint lithography in the manufacture of ICs, it should be understood that imprint apparatus and methods described may have other applications, such as the manufacture of integrated optical systems, guidance and detection patterns for magnetic domain memories, hard disk magnetic media, flat panel displays, thin-film magnetic heads, etc.

While in the description above particular reference has been made to the use of imprint lithography to transfer a template pattern to a substrate via an imprintable resin effectively acting as a resist, in some circumstances the imprintable material may itself be a functional material, for instance having a functionally such as conductivity, optical linear or non linear response, etc. For example, the functional material may form a conductive layer, a semiconductive layer, a dielectric layer or a layer having another desirable mechanical, electrical or optical property. Some organic substances may also be appropriate functional materials. Such applications may be within the scope of one or more embodiments of the invention.

In an embodiment, the imprint lithography process includes two etching steps after the patterning template has been removed. As detailed above, the first etch (to remove the residual layer of cured resin) is isotropic and non-selective, and reduces the aspect ratio of the printed features, which is undesirable. The second etch (into the planarization and transfer layer) is selective and improves the aspect ratio of the printed features.

The first etch removes material from both printed features and the residual layer. The removal of material from the desired printed features has an effect on the second etch because any erosion of the integrity of the printed features will have an effect on the critical dimension of the pattern formed in the second etch. This is exacerbated if the residual layer is non-uniform, which can occur, for example, if the template is not applied parallel to the printing surface and can result in loss of the printed pattern with the non-selective first etch.

Consequently, strict dimensions are typically imposed on the thickness and uniformity of the residual layer. The residual layer must be thinner than the size of the printed features (otherwise the features are etched away before the residual layer) and similarly the variation in thickness of the residual layer of the area of printing must be less than the size of the printed features. Satisfying these strict dimensions is typically difficult and may cause problems during the imprinting process.

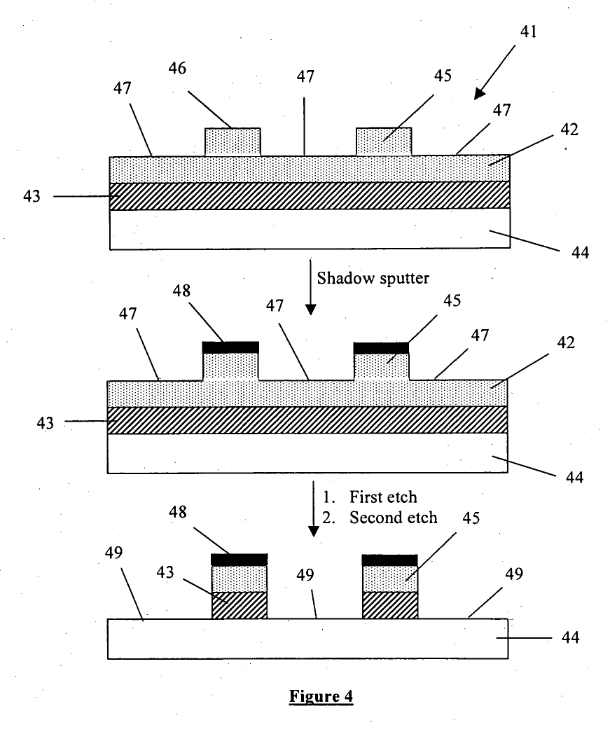

An embodiment illustrated in FIG. 4 attempts to overcome one or more problems of the non-selective first etch by inserting an additional step prior to etching which makes the first etch selective.

A partially fabricated device 41 comprises a layer of an imprinted medium 42 supported on a planarization and transfer layer 43 which is itself supported on a substrate 44. The imprinted medium 42 has been previously imprinted so as to define a pair of upstanding pattern features 45 having upper surfaces 46, and areas of reduced thickness 47.

A layer of an etch-resistant material 48 is deposited on the upper surfaces 46 of the pattern features 45 after the template (not shown) has been removed and before the first etch is applied to remove the areas of reduced thickness 47. In an embodiment, the etch-resistant material 48 is applied by a material dosing device. In an embodiment, the material dosing device is a low angle shadow sputtering device although other material dispensing mechanisms may be employed including other appropriate deposition and/or sputtering devices. Thus, the etch-resistant material 48 is supplied at a low angle with a shadow sputter technique in such a way that it is only deposited on the upper surfaces 46 of the pattern features 45, leaving the areas of reduced thickness 47 uncovered. The first etch may therefore become selective in that only the areas of reduced thickness 47 are etched away, and the aspect ratio of the pattern features 45 may be improved ready for the second etch. Even non-uniform areas of reduced thickness may be removed without adversely affecting the printed features. The second etch is then carried out in the usual way to remove exposed areas of the planarization and transfer layer 43 to expose the areas 49 of the substrate to be patterned in subsequent process steps.

This embodiment has an advantage in that it enables a wider choice of materials for the imprintable medium (e.g., curable resin) and the planarization and transfer layer because these are often limited to materials which have the desired etching properties. Since the etching properties are now determined solely by the material deposited on the tops of the printed features, the choice of imprintable material may be improved.

While specific embodiments of the invention have been described above, it will be appreciated that the invention may be practiced otherwise than as described. The description is not intended to limit the invention.

1. An imprinting method, comprising:
contacting an imprintable medium on a substrate with a template to form an imprint in the medium comprising a pattern feature and an area of reduced thickness;
separating the template from the imprinted medium; and
after separating the template from the imprinted medium, providing a layer of an etch resistant material on the pattern feature.

2. The method according to claim 1, further comprising providing a volume of the imprintable medium on the substrate.

3. The method according to claim 1, comprising providing the etch resistant material only on the pattern feature.

4. The method according to claim 1, comprising providing the etch resistant material on a surface of the pattern feature which is distal from the substrate.

5. The method according to claim 1, comprising providing the etch resistant material on the pattern feature by low angle deposition.

6. The method according to claim 1, comprising providing the etch resistant material on the pattern feature by shadow sputtering.

7. The method according to claim 1, further comprising etching the area of reduced thickness to expose a region of a surface of the substrate.

8. The method according to claim 7, further comprising etching the exposed region of the surface of the substrate.

9. The method according to claim 1, wherein an intermediate layer is provided between the substrate and the imprintable medium.

10. The method according to claim 9, further comprising etching the area of reduced thickness to expose a region of a surface of the intermediate layer.

11. The method according to claim 10, further comprising etching the exposed region of the surface of the intermediate layer to expose a region of a surface of the substrate.

12. The method according to claim 11, further comprising etching the exposed region of the surface of the substrate.

13. A method for patterning a substrate, comprising:
contacting an imprintable medium on a substrate with a template to form an imprint in the medium comprising a pattern feature and an area of reduced thickness;
separating the template from the imprinted medium;
providing a layer of an etch resistant material on the pattern feature;
etching the area of reduced thickness to expose a region of the substrate; and
etching the exposed region of the substrate.

14. The method according to claim 13, further comprising providing a volume of the imprintable medium on the substrate.

15. The method according to claim 13, comprising providing the etch resistant material only on the pattern feature.

16. The method according to claim 13, comprising providing the etch resistant material on a surface of the pattern feature which is distal from the substrate.

17. The method according to claim 13, comprising providing the etch resistant material on the pattern feature by low angle deposition.

18. The method according to claim 13, comprising providing the etch resistant material on the pattern feature by shadow sputtering.

19. An imprinting apparatus, comprising:
a substrate holder configured to hold a substrate having an imprintable medium thereon;
a template holder configured to cause a template supported by the template holder to contact the medium to form an imprint in the medium, the imprint comprising a pattern feature and an area of reduced thickness, and to cause the template to separate from the imprinted medium; and
a material dosing device configured to provide a layer of an etch resistant material on the pattern feature.

20. The apparatus according to claim 19, further comprising a dosing apparatus configured to provide a volume of the imprintable medium on a substrate.

21. The apparatus according to claim 19, wherein the material dosing device is operable to provide the etch resistant material only on the pattern feature.

22. The apparatus according to claim 19, wherein the material dosing device is operable to provide the etch resistant material on a surface of the pattern feature which is distal from the substrate.

23. The apparatus according to claim 19, wherein the material dosing device comprises a low angle deposition device.

24. The apparatus according to claim 19, wherein the material dosing device comprises a shadow sputtering device.
